(19) United States
(12) Patent Application Publication
(10) Pub. No.: US 2008/0094288 A1
(43) Pub. Date: Apr. 24, 2008

(54) Multi-frequency antenna and electronic device having the same

(75) Inventors: Yuan-li Chang, Taipei Hsien (TW); Jiunn-ming Huang, Taipei Hsien (TW)

Correspondence Address: BACON & THOMAS, PLLC, 625 SLATERS LANE, FOURTH FLOOR, ALEXANDRIA, VA, 22314, US

(73) Assignee: WISTRON NEWEB CORP., Taipei Hsien (TW)

(21) Appl. No.: 11/896,964

(22) Filed: Sep. 7, 2007

(30) Foreign Application Priority Data
Oct. 20, 2006 (TW) 095218594

(51) Int. Cl. H01Q 9/04; H01Q 1/38

(52) U.S. Cl. 343/700 MS

(57) ABSTRACT

The present invention provides a multi-frequency antenna and an electronic device having the same. The multi-frequency antenna comprises a radiating element, a grounding element and a connecting element. The radiating element comprises a high-frequency radiating unit and a low-frequency radiating unit, wherein the low-frequency radiating unit is constructed by bending a horizontal plane where the high-frequency radiating unit is located in an upward manner by a certain height to form a three-dimensional structure; and the connecting element is used to connect the radiating element and the grounding element.

### BACKGROUND OF THE INVENTION

1. Field of the Invention

The present invention relates to a multi-frequency antenna and an electronic device having the same, and more particularly, to a multi-frequency antenna which reduces the space requirement for installation and an electronic device which comprises the multi-frequency antenna.

2. Description of the Related Art

With the evolution of wireless communication technology, electronic devices such as cellular phones, personal digital assistants (PDAs), notebook computers and the like are exploiting wireless communication technology for data transmission. In precedent technology, these electronic devices were normally installed with an antenna that served as a medium for detection of electromagnetic signals to enable wireless communication.

As an example, a United States patent with U.S. Pat. No. 6,861,986 has disclosed a multi-frequency inverted-F antenna in the precedent technology which can be installed into electronic devices. Refer to FIG. 1, which shows an antenna 90. The antenna 90 is a planar inverted-F antenna; the antenna 90 comprises: a radiating element 91, a connecting element 92 and a grounding element 93, wherein the connecting element 92 is used to connect the radiating element 91 and the grounding element 93. The radiating element 91 comprises a high-frequency radiating unit 911 and a low-frequency radiating unit 912 which correspond to the high-frequency band and the low-frequency band respectively.

To date, many standards co-exist in the field of wireless communication. With the advance of technologies, electronic devices are becoming lighter and smaller, and antennas must also be reduced in size in order to be installed into an ever limited space within these electronic devices. Therefore, antenna related manufacturers, vendors and users are still waiting for the advent of an antenna that is reduced in size; has a band coverage that complies with the common wireless communication standards and possesses effective antenna properties at the same time.

### SUMMARY OF THE INVENTION

In order to resolve the aforementioned problems in the precedent technology and to conform with the present trend of ever smaller and lighter electronic devices, the present invention provides a multi-frequency antenna which reduces the space requirement for installation and an electronic device that comprises the multi-frequency antenna.

The present invention provides a multi-frequency antenna comprising:
a radiating element, a grounding element and a connecting element, and the connecting element is used to connect the radiating element and the grounding element. The radiating element comprises a high-frequency radiating unit and a low-frequency radiating unit, wherein the low-frequency radiating unit is constructed by bending a horizontal plane where the high-frequency radiating unit is located in an upward manner by a certain height to form a three-dimensional structure.

In one of the preferred embodiments of the present invention, the high-frequency radiating unit is located on the same plane as the grounding element; the low-frequency radiating unit is constructed by bending the horizontal plane where the high-frequency radiating unit is located in an upward manner by a certain height to form a U-shaped three-dimensional structure.

In another preferred embodiment of the present invention, both the low-frequency and the high-frequency radiating unit comprise a bending part at one end, wherein the bending parts are essentially rectangular-shaped. An interconnecting point of the connecting element and the radiating element is essentially triangular-shaped.

### BRIEF DESCRIPTION OF THE DRAWINGS

FIG. 1 is a diagram showing an antenna in conventional technology.

FIG. 2 is a diagram showing a multi-frequency antenna of the present invention.

FIG. 3 is a diagram showing a multi-frequency antenna of the present invention.

FIG. 4 is an efficiency graph of an antenna in conventional technology.

FIG. 5 is an efficiency graph of a multi-frequency antenna of the present invention.

FIG. 6 is a voltage standing wave ratio graph of an antenna in conventional technology.

FIG. 7 is a voltage standing wave ratio graph of a multi-frequency antenna of the present invention.

FIG. 8 is diagram showing a notebook computer which possesses a multi-frequency antenna in accordance with the present invention.

FIG. 9 is diagram showing a cellular phone which possesses a multi-frequency antenna in accordance with the present invention.

FIG. 10 is diagram showing a personal digital assistant which possesses a multi-frequency antenna in accordance with the present invention.

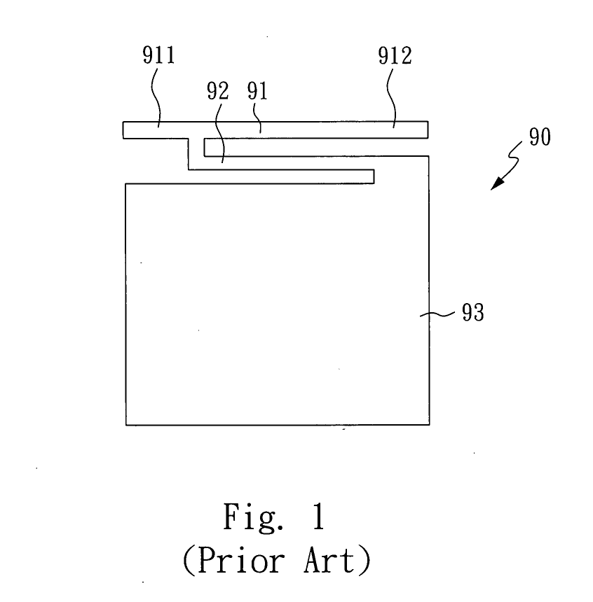

### DETAILED DESCRIPTION OF THE PREFERRED EMBODIMENT

The advantages and innovative features of the invention will become more apparent from the following detailed description when taken in conjunction with the accompanying drawings.

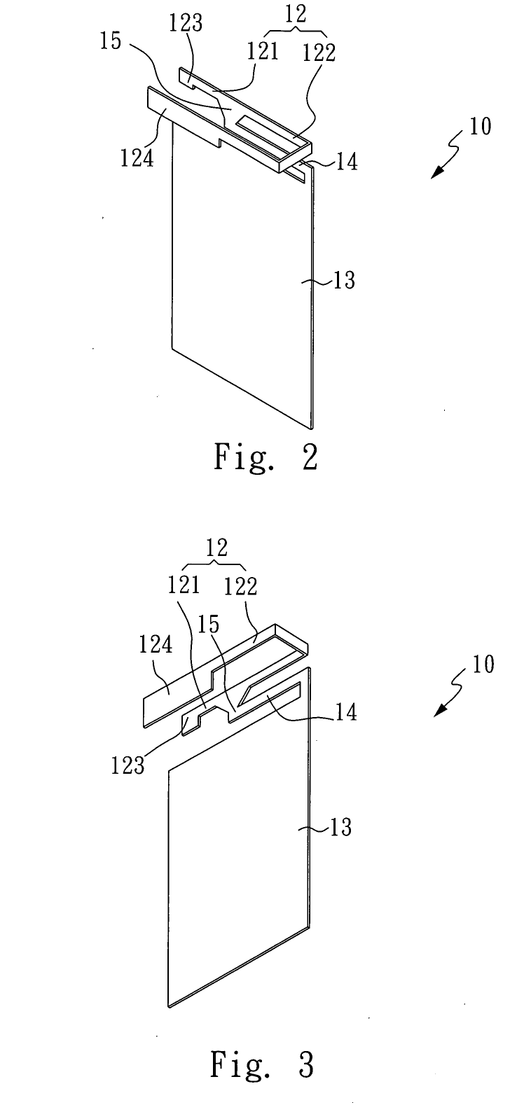

First, with reference to FIG. 2 and FIG. 3, these show a multi-frequency antenna in accordance with the present invention. As depicted in FIG. 2 and FIG. 3, the multi-frequency antenna 10 comprises a radiating element 12, a grounding element 13 and a connecting element 14, wherein the radiating element 12, the grounding element 13 and the connecting element 14 can be made of effective electrical conductors such as copper alloy, but the present invention is not confined to this material. There are two ends on the connecting element 14, wherein one end is connected to the radiating element 12, and the other end is connected to the grounding element 13. The radiating element 12 comprises a high-frequency radiating unit 121 and a low-frequency radiating unit 122 which correspond to the high-frequency band (approximately 5.2 GHz or 5.8 GHz wireless signal) and the low-frequency band (approximately 2.4 GHz wireless signal) respectively. The radiating element 12 is connected to the grounding element 13 via the connecting element 14, and the high-frequency radiating unit 121 is located on the same plane as the grounding element 13; however, the present invention is not confined to this arrangement. The low-frequency radiating unit 122 is a U-shaped three-dimensional structure and is formed through bending the horizontal plane where the high-frequency radiating unit is located in an upward manner by a certain height. In another embodiment of the present invention, the high-frequency radiating unit 121 is connected to one end of the U-shaped three-dimensional structure of the low-frequency radiating unit 122, and the other end of the U-shaped three-dimensional structure is parallel to the high-frequency radiating unit 121. However, the present invention is not confined to this arrangement.

As compared with an antenna 90 in conventional technology, the three-dimensional design of the radiating element 12 of the multi-frequency antenna 10 in the present invention is able to reduce the surface area of the grounding element 13, which further reduces the overall surface area of antenna 10, and as a result, reduces the space requirement for installation. For example, if the antenna 90 in conventional technology requires an overall surface area of 30 mm×30 mm, then the multi-frequency antenna 10 in the present invention only requires an overall surface area of 30 mm×17 mm through the use of the three-dimensional design of the radiating element 12.

As depicted in FIG. 2 and FIG. 3, the high-frequency radiating unit 121 is a strip-shaped metal plate, which comprises a rectangular-shaped bending part 123 at one end, but the present invention is not confined to a rectangular shape and can be other shapes. Similarly, on the other end of the U-shaped three-dimensional structure of the low-frequency radiating unit 122 (the end which is parallel to the high-frequency radiating unit 121 of this embodiment) is a rectangular-shaped bending part 124, but the present invention is not confined to a rectangular shape and can be other shapes. Through the design of the bending parts 123 and 124, the multi-frequency antenna 10 of the present invention is able to achieve size reduction but still maintain the antenna's properties similar to that of the antenna 90 in conventional technology.

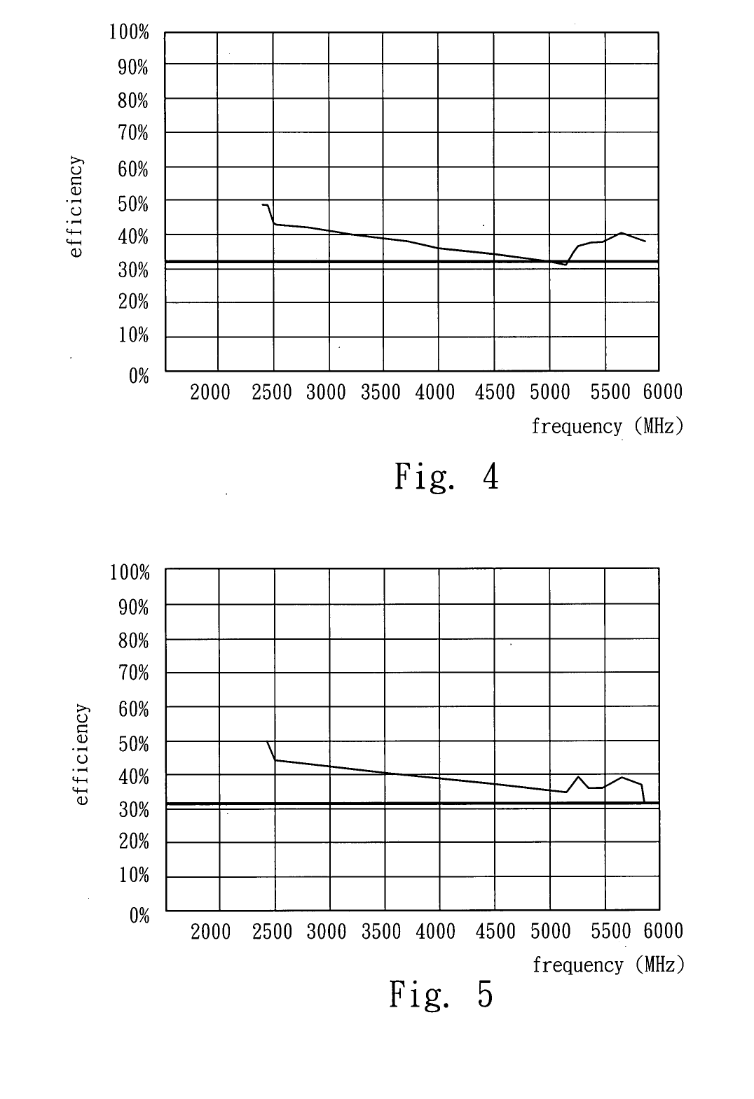

With reference to FIG. 4 and FIG. 5, these show the efficiency graphs of the antenna 90 in conventional technology and a multi-frequency antenna 10 in the present invention respectively. As depicted in FIG. 4, the efficiency of the antenna 90 in the precedent technology between 2.4 GHz to 5.8 GHz is more than 30%. Similarly, as depicted in FIG. 5, the efficiency of the multi-frequency antenna 10 in the present invention between 2.4 GHz to 5.8 GHz is also more than 30%.

As a result, it can be concluded that the multi-frequency antenna 10 of the present invention is able to be reduced in size but still maintain similar, or even obtain better antenna properties as compared with the antenna 90 in the precedent technology.

As depicted in FIG. 2 and FIG. 3, the radiating element 12 is connected to the grounding element 13 through the connecting element 14. An interconnecting point 15 where the radiating element 12 and the connecting element 14 interconnects is located on the vertex of a triangular shape of the connecting element 14, wherein the interconnecting point 15 can be used as a feed point by electronically connecting it to a feed line (not shown in the figure) for transmitting signals.

The multi-frequency antenna 10 of the present invention is able to achieve size reduction through the design of the triangular interconnecting point 15 and maintain the antenna properties similar to that of the antenna 90 in conventional technology.

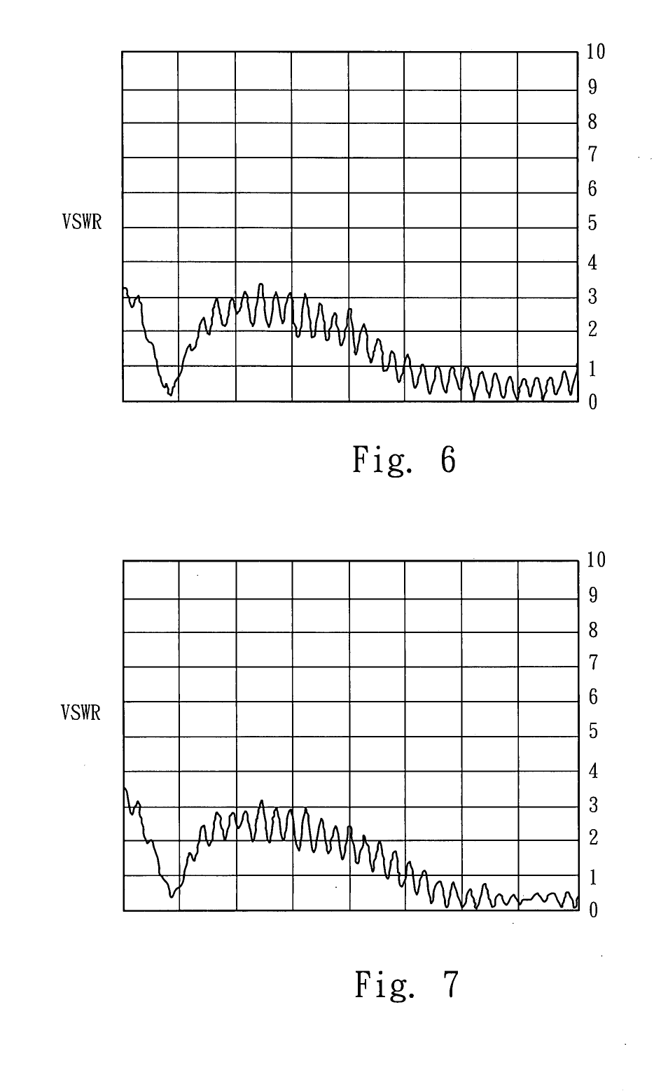

Refer to FIG. 6 and FIG. 7, these show the voltage standing wave ratio (VSWR) of the antenna 90 in conventional technology and of the multi-frequency antenna 10 in the present invention respectively. As depicted in FIG. 6 and FIG. 7, the VSWR curve of the multi-frequency antenna 10 in the present invention is similar to that of the antenna 90 in the precedent technology. As a result, it can be concluded that the multi-frequency antenna 10 of the present invention is able to be reduced in size but still maintain similar, or even obtain better antenna properties as compared with the antenna 90 in the precedent technology.

The multi-frequency antenna 10 is able to reduce the total surface area through the above design, such that it can be installed into devices which have limited space for installation.

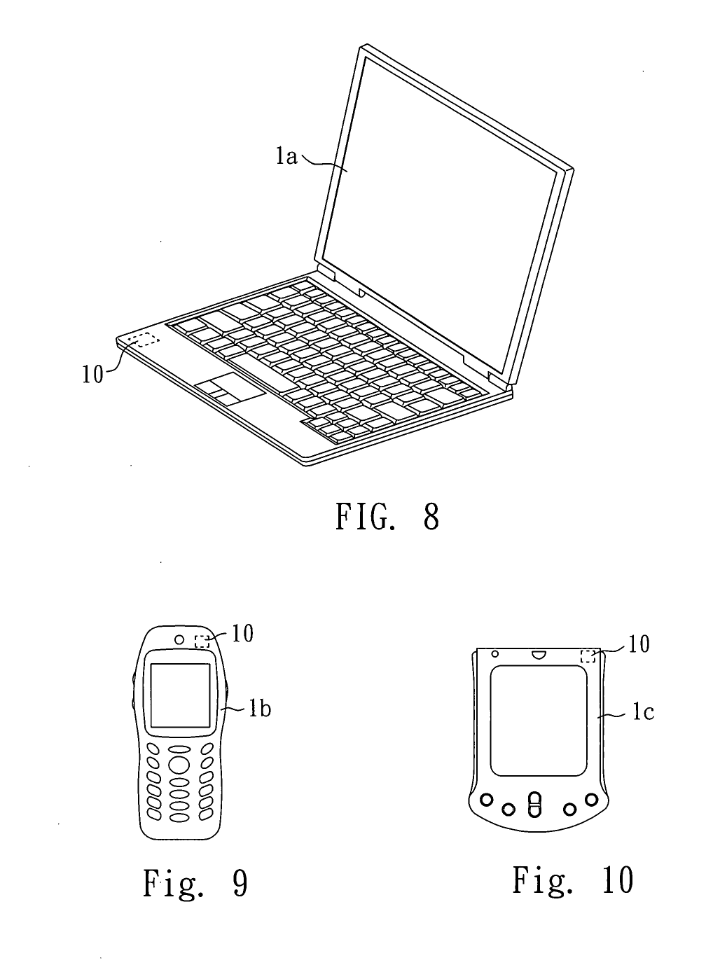

The present invention then provides an electronic device which comprises a multi-frequency antenna 10. Refer to FIG. 8 to FIG. 10 for an electronic device of the present invention. As depicted in FIG. 8 to FIG. 10, the electronic device of the present invention can be a notebook computer 1a, a cellular phone 1b or a personal digital assistant 1c.

Each one, the notebook computer 1a, the cellular phone 1b and the personal digital assistant 1c has a multi-frequency antenna 10 to achieve the transmission and reception of wireless signals. Take note that the multi-frequency antenna 10 is not restricted to the positions as depicted in FIG. 8 to FIG. 10. In other words, the multi-frequency antenna 10 can be located at different positions according to different design requirements.

Although the present invention has been explained in relation to its preferred embodiment, it is to be understood that many other possible modifications and variations can be made without departing from the spirit and scope of the invention as hereinafter claimed.

What is claimed is:

1. A multi-frequency antenna, comprising:
a radiating element comprising a high-frequency radiating unit and a low-frequency radiating unit, wherein the low-frequency radiating unit is constructed by bending a horizontal plane where the high-frequency radiating unit is located in an upward manner by a certain height to form a three-dimensional structure;
a grounding element; and
a connecting element, which is used to connect the radiating element and the grounding element.

2. The multi-frequency antenna as claimed in claim 1, wherein the high-frequency radiating unit is located on the same horizontal plane as the grounding element.

3. The multi-frequency antenna as claimed in claim 1, wherein the low-frequency radiating unit forms a U-shaped three-dimensional structure.

4. The multi-frequency antenna as claimed in claim 3, wherein the low-frequency radiating unit is constructed by bending the horizontal plane where the high-frequency radiating unit is located in an upward manner by a certain height to form the U-shaped three-dimensional structure.

5. The multi-frequency antenna as claimed in claim 1, wherein the low-frequency radiating unit comprises a bending part at one end.

6. The multi-frequency antenna as claimed in claim 5, wherein the bending part is essentially rectangular-shaped.

7. The multi-frequency antenna as claimed in claim 1, wherein the high-frequency radiating unit is a strip-shaped metal plate, and the strip-shaped metal plate comprises a bending part at one end.

8. The multi-frequency antenna as claimed in claim 7, wherein the bending part is essentially rectangular-shaped.

9. The multi-frequency antenna as claimed in claim 1, wherein an interconnecting point of the connecting element and the radiating element is essentially triangular-shaped.

10. An electronic device which can be used for wireless communication, the electronic device comprising:
a multi-frequency antenna, which comprises:
a radiating element comprising a high-frequency radiating unit and a low-frequency radiating unit, wherein the low-frequency radiating unit is constructed by bending a horizontal plane where the high-frequency radiating unit is located in an upward manner by a certain height to form a three-dimensional structure;
a grounding element; and
a connecting element, which is used to connect the radiating element and the grounding element.

11. The electronic device as claimed in claim 10, wherein the high-frequency radiating unit is located on the same horizontal plane as the grounding element.

12. The electronic device as claimed in claim 10, wherein the low-frequency radiating unit forms a U-shaped three-dimensional structure.

13. The electronic device as claimed in claim 12, wherein the low-frequency radiating unit is constructed by bending the horizontal plane where the high-frequency radiating unit is located in an upward manner by a certain height to form the U-shaped three-dimensional structure.

14. The electronic device as claimed in claim 10, wherein the low-frequency radiating unit comprises a bending part at one end.

15. The electronic device as claimed in claim 14, wherein the bending part is essentially rectangular-shaped.

16. The electronic device as claimed in claim 10, wherein the high-frequency radiating unit is a strip-shaped metal plate, and the strip-shaped metal plate comprises a bending part at one end.

17. The electronic device as claimed in claim 16, wherein the bending part is essentially rectangular-shaped.

18. The electronic device as claimed in claim 10, wherein an interconnecting point of the connecting element and the radiating element is essentially triangular-shaped.
